(19) United States
(12) Patent Application Publication
(10) Pub. No.: US 2017/0127049 A1
(43) Pub. Date: May 4, 2017

(54) OBJECT SCANNING METHOD

(71) Applicant: INDUSTRIAL TECHNOLOGY RESEARCH INSTITUTE, Hsinchu (TW)

(72) Inventors: Shang-Yi LIN, Taichung City (TW); Chia-Chen CHEN, Hsinchu City (TW); Wen-Shiou LUO, Hsinchu City (TW)

(73) Assignee: INDUSTRIAL TECHNOLOGY RESEARCH INSTITUTE, Hsinchu (TW)

(21) Appl. No.: 14/928,258

(22) Filed: Oct. 30, 2015

(51) Int. Cl. H04N 13/02; G06T 17/00; G06T 7/00

(52) U.S. Cl. CPC H04N 13/0282; H04N 13/0296; H04N 13/0246; G06T 7/002; G06T 17/00; G06T 2207/10028; G06T 2207/10016

(57) ABSTRACT

An object scanning method comprising following steps is provided. An object is scanned and a depth information of the object is captured by a depth sensor. A motor is moved and another depth information of the object after the movement of the motor is captured at least once. Under the circumstance that the axis coordinate of the motor are not calibrated, a movement amount of the motor is captured. A comparison of at least one feature point is made between two depth information of the object according to the movement amount of the motor, and an iterative algorithm is used to obtain corresponding coordinate of each feature point until the comparison of each feature point is completed. A 3D model of the object is created according to the corresponding coordinate of each feature point.

### TECHNICAL FIELD

The disclosure relates to an object scanning method.

### BACKGROUND

The object scanning method can be divided into two types. According to one type of the object scanning method, a feature on the object is scanned and used as information for feature comparison. According to another type of the object scanning method, movement of an object is controlled by a motor, feature comparison step is replaced with coordinate information about the movement of the motor, and a profile of the object is directly scanned. However, coordinate positions of the motor and the depth sensor need to be calibrated at first such that the axis coordinate and shaft direction of the motor can be confirmed.

However, for the object with symmetric feature (such as a pattern with translational or rotational symmetry), it is very likely that the comparison result is incorrect when the feature on the object is used for scanning. In order to obtain a correct comparison result, the motor must be manually calibrated or the axis coordinate of the motor must be known in advance.

### SUMMARY

According to one embodiment, an object scanning method comprising following steps is provided. An object is scanned and a depth information of the object is captured by a depth sensor. A motor is moved and another depth information of the object after the movement of the motor is captured at least once. Under the circumstance that the axis coordinate of the motor are not calibrated, a movement amount of the motor is captured. A comparison of at least one feature point is made between two depth information of the object according to the movement amount of the motor, and an iterative algorithm is used to obtain corresponding coordinate of each feature point until the comparison of each feature point is completed. A 3D (three-dimensional) model of the object is created in the coordinate system of the motor according to the corresponding coordinate of each feature point.

According to another embodiment, an object scanning method comprising following steps is provided. An user defines axis coordinate and a shaft direction of a motor and sets a movement ratio of the motor in a known movement direction. A depth sensor is used to scan an object and captures a depth information of the object. A motor is moved and another depth information of the object after the movement of the motor is captured at least once. A movement amount of the motor is captured. A comparison of at least one feature point is made between two depth information of the object according to the known movement ratio of the motor, and an iterative algorithm is used to obtain corresponding coordinate of each feature point until the comparison of each feature point is completed. A 3D (three-dimensional) model of the object is created in the coordinate system of the motor according to the corresponding coordinate of each feature point.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is an architecture diagram of a scanning system used in the disclosure.

FIG. 2 is a flowchart of an object scanning method according to an embodiment of the disclosure.

FIG. 3 is a flowchart of feature comparison step according to an embodiment.

FIG. 4 is a flowchart of feature comparison step according to an embodiment.

FIG. 5 is a flowchart of an object scanning method according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the disclosure. However, the embodiments of the disclosure are for detailed descriptions only, not for limiting the scope of protection of the disclosure.

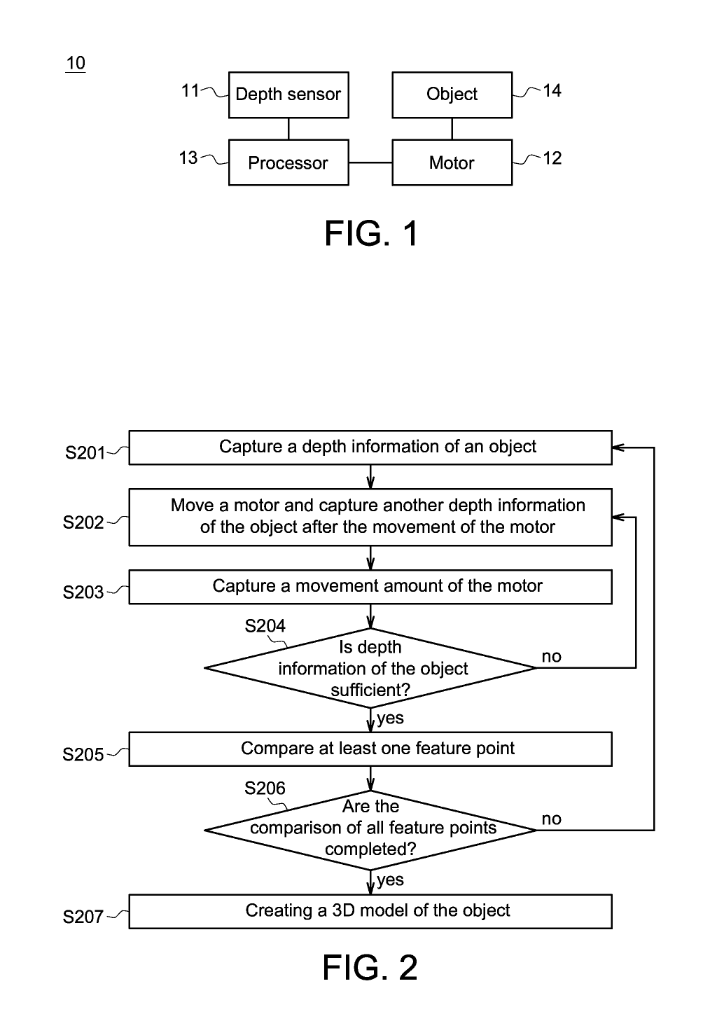

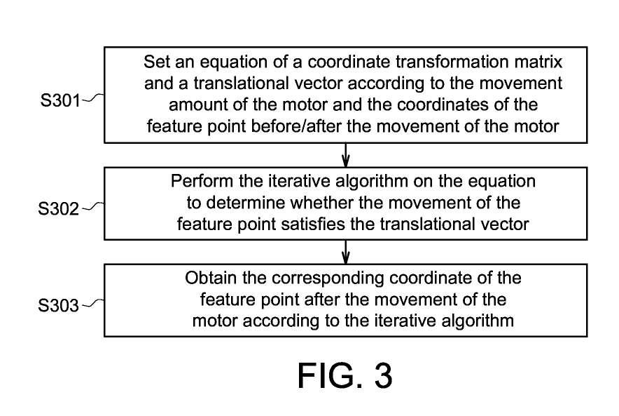

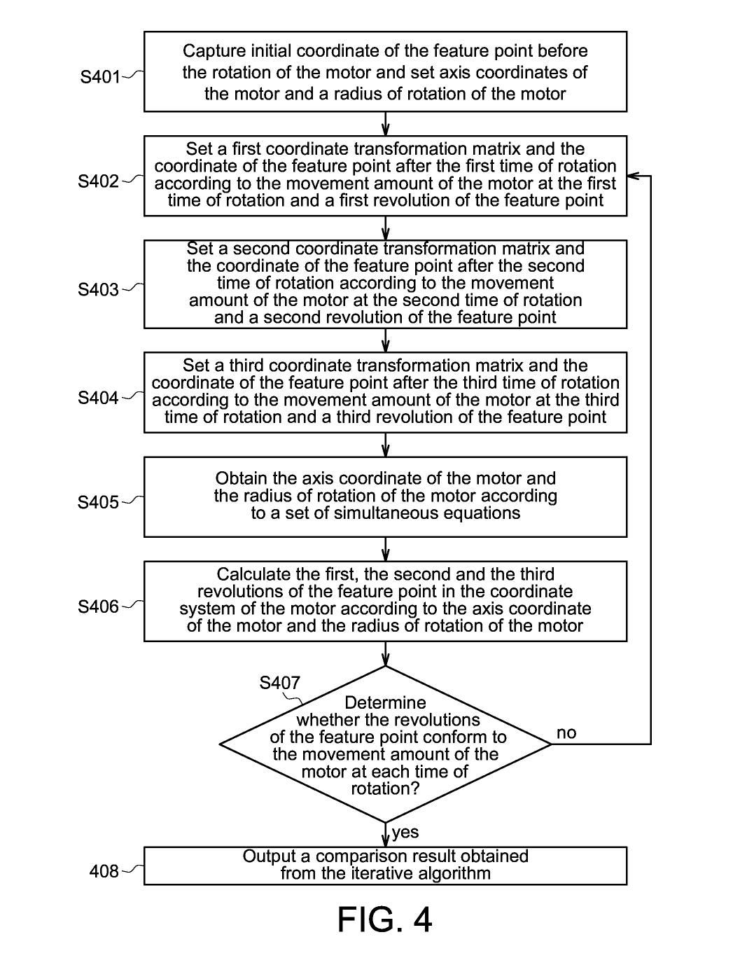

Referring to FIG. 1, an architecture diagram of a scanning system used in the disclosure is shown. The scanning system mainly comprises a depth sensor 11, a motor 12 and a processor 13. The depth sensor 11, such as a video camera, is for capturing a depth information of an object 14. The object 14 is disposed on a movable platform of the motor 12. The motor 12 controls the movement amount required for the object 14 with respect to the depth sensor 11 in a translational or a rotational manner. The processor 13 receives a depth information of the object 14 before/after the movement of the motor 12 and comparing the information of at least one feature point between two depth information of the object 14 according to the movement amount of the motor 12. Thus, feature comparison can be made when at least one feature point appearing in two depth information of the object 14 is captured. Details of the step of comparing the feature point can be found with reference to the flowcharts of FIG. 3 and FIG. 4.

In an embodiment, the object 14 has a pattern with rotational or translational symmetry. However, when the depth sensor 11 captures a depth information of the pattern with symmetric feature, if the processor 13 does not have the movement information of the motor 12 (such as distance of movement or angle of rotation) and performs comparison according to the depth information only, comparison error will occur during the composite processing due to symmetric features. Suppose the movement information of the motor 12 is unknown. When the motor 12 is translated, feature comparison will produce more than two corresponding results if the object 14 has a feature of translational symmetry. Under such circumstance, the obtained results may be incorrect. When the motor 12 is rotated, feature comparison will produce more than two corresponding results if the object 14 has a feature of translational or rotational symmetry. Thus, the only solution cannot be obtained from the result of calculation (the result of calculation produces more than one solution).

Therefore, in the object scanning method of the present embodiment, the comparison of the feature point adopts an iterative algorithm and the movement information of the motor 12 is used as constraints during the comparison of the feature point, such that corresponding coordinate of each feature point can be found out and a 3D model of the object 14 can be created. In the disclosure, the iterative algorithm can adopt a parallel tracking and mapping (PTAM) method or an iterative closest point (ICP) method to find out a most suitable coordinate transformation matrix.

Refer to both FIGS. 1 and 2. FIG. 2 is a flowchart of an object scanning method according to an embodiment of the disclosure. Firstly, in step S201, an object 14 is scanned and a depth information of the object 14 is captured by a depth sensor 11. In step S202, a motor 12 is moved and another depth information of the object 14 after the movement of the motor 12 is captured again. In step S203, a movement amount of the motor 12 is captured under the circumstance that the axis coordinate of the motor 12 are not calibrated. Then, in step S204, if the depth information of the object 14 is insufficient, the method returns to S202, the motor 12 is again moved and another depth information of the object 14 after the movement of the motor 12 is captured again until the captured depth information is sufficient for feature comparison. In step S205, at least one feature point of the depth information is compared and an iterative algorithm is performed to obtain corresponding coordinate of each feature point. In step S206, after the comparison of each feature point is completed, step S207 is proceeded, a 3D model of the object 14 is created in the coordinate system of the motor 12 according to the corresponding coordinate of each feature point.

In step S202, when the motor 12 is moved linearly, feature comparison of step S205 can be performed as long as at least one depth information of the object 14 after the movement of the motor 12 is captured according to the movement amount (distance) of the motor 12. However, when the motor 12 is rotated, the depth information of the object 14 each time after the rotation of the motor 12 must be captured at least three times according to the movement amount (angle of rotation) of the motor 12 at each time of rotation to produce sufficient depth information for feature comparison of step S205. Besides, at each time of movement of the motor 12, the axial direction of the motor 12 refers to the same axis. If more than two axial directions are moved at the same time (for example, the motor is both translated and rotated), respective information of each axis will not be calculated. Therefore, the motor 12 only moves in one of the axes at each time of movement.

Refer to both FIGS. 1 and 3. FIG. 3 is a flowchart of feature comparison step according to an embodiment. In step S301, when the motor 12 is moved linearly, an equation of a coordinate transformation matrix from the coordinate system of the depth sensor 11 to the coordinate system of the motor 12 and a translational vector of a movement of the feature point in the coordinate system of the motor 12 are set according to the movement amount of the motor 12 and corresponding coordinates of the feature point before/after the movement of the motor 12. The movement amount of the motor 12 is set as X, the translational vector is set as [tₓ, t_{y}, t_{z}], and tₓ²+t_{y}²+t_{z}²=X². In step S302, an iterative algorithm is performed on the equation to determine whether the movement of each feature point satisfies the translational vector. Then, step S303 is proceeded, the corresponding coordinate of each feature point after the movement of the motor 12 is obtained by using the iterative algorithm.

An equation expressed below is obtained according to the movement amount of the motor 12 and the corresponding coordinate of each feature point.

$$[ \begin{matrix}{n}_{x} & {n}_{y} & {n}_{z}\end{matrix} ] ( M \times [ \begin{matrix}{p}_{x} \\ {p}_{y} \\ {p}_{z} \\ 1\end{matrix} ] - [ \begin{matrix}{q}_{x} \\ {q}_{y} \\ {q}_{z}\end{matrix} ] ) = 0 \\ M = [ \begin{matrix}\begin{matrix}( 1 - cos ( w ) ) \\ {r}_{x}^{2} + cos ( w )\end{matrix} & \begin{matrix}( 1 - cos ( w ) ) \\ {r}_{x} {r}_{y} - sin ( w ) {r}_{z}\end{matrix} & \begin{matrix}( 1 - cos ( w ) ) \\ {r}_{x} {r}_{z} + sin ( w ) {r}_{x}\end{matrix} & {t}_{x} \\ \begin{matrix}( 1 - cos ( w ) ) \\ {r}_{x} {r}_{y} + sin ( w ) {r}_{z}\end{matrix} & \begin{matrix}( 1 - cos ( w ) ) \\ {r}_{y}^{2} + cos ( w )\end{matrix} & \begin{matrix}( 1 - cos ( w ) ) \\ {r}_{y} {r}_{z} - sin ( w ) {r}_{x}\end{matrix} & {t}_{y} \\ \begin{matrix}( 1 - cos ( w ) ) \\ {r}_{x} {r}_{z} - sin ( w ) {r}_{y}\end{matrix} & \begin{matrix}( 1 - cos ( w ) ) \\ {r}_{y} {r}_{z} + sin ( w ) {r}_{x}\end{matrix} & \begin{matrix}( 1 - cos ( w ) ) \\ {r}_{z}^{2} + cos ( w )\end{matrix} & {t}_{z}\end{matrix} ] \qquad ( 1 )$$

Wherein, M represents a coordinate transformation matrix; (Pₓ, P_{y}, P_{z}) represents the coordinate of a feature point in the first depth information; (qₓ, q_{y}, q_{z}) represents the coordinate of the same feature point in the second depth information; (n_{y}, n_{y}, n_{z}) represents a normal vector of a feature point (qₓ, q_{y}, q_{z}); (tₓ, t_{y} t_{z}) represents a translational vector; w represents a rotation angle which forms a rotation matrix with the shaft direction (rₓ, r_{y}, r_{z}) of the motor.

When the motor 12 is translated, the value of w in the equation (1) is set as 0 and the translational vector (tₓ, t_{y}, t_{z}) is set to be same as a movement amount X of the motor 12, such that a correct comparison position can be found. In addition, when the motor 12 is rotated, the value of w cannot be set as 0 because there is no guaranty that the axis of the motor 12 will be on the coordinate axis of the depth sensor 11. Therefore, when the motor 12 is rotated, the movement of the object 14 will comprise translational and rotational movements, and three coordinate transformation matrixes are required for finding out a correct comparison position.

Refer to FIGS. 1 and 4. FIG. 4 is a flowchart of feature comparison step according to an embodiment. In step S401, when the motor 12 rotates around a fixed axial direction (such as X-axis, Y-axis or Z-axis), initial coordinate [Px0, Py0, Pz0] of the feature point before the movement of the motor 12 is captured, axis coordinate of the motor 12 are set as (A, B, C), and the radius of rotation of the motor 12 is set as R, wherein (Px0−A)²+(Py0−B)²+(Pz0−C)²=R². In step S402, a first coordinate transformation matrix from the coordinate system of the depth sensor 11 to the coordinate system of the motor 12 and the coordinate [Px1, Py1, Pz1] of the feature point of the motor 12 after the first time of rotation are set according to the movement amount of the motor 12 at the first time of rotation and a first revolution of the feature point in the coordinate system of the motor 12, wherein (Px1−A)²+(Py1−B)²+(Pz1−C)²=R². In step S403, a second coordinate transformation matrix from the coordinate system of the depth sensor 11 to the coordinate system of the motor 12 and the coordinate [Px2, Py2, Pz2] of the feature point after the second time of rotation are set according to the movement amount of the motor 12 at the second time of rotation and a second revolution of the feature point in the coordinate system of the motor 12, wherein (Px2−A)²+(Py2−B)²+(Pz2−C)²=R². In step S404, a third coordinate transformation matrix from the coordinate system of the depth sensor 11 to the coordinate system of the motor 12 and the coordinate [Px3, Py3, Pz3] of the feature point after the third time of rotation are set according to the movement amount of the motor 12 at the third time of rotation and a third revolution of the feature point in the coordinate system of the motor 12, wherein (Px3−A)²+(Py3−B)²+(Pz3−C)²=R².

In steps S401-S403, suppose the rotation direction of the motor 12 is (rₓ, r_{y}, r_{z}), the rotation angle of the motor 12 is w, and the revolution vector of the feature point at each time of rotation is set as (tₓ, t_{y}, t_{z}), a coordinate transformation matrix M can be expressed as follows:

$$[ \begin{matrix}\begin{matrix}( 1 - cos ( w ) ) {r}_{x}^{2} + \\ cos ( w )\end{matrix} & \begin{matrix}1 - cos ( w ) {r}_{x} {r}_{y} - \\ sin ( w ) {r}_{z}\end{matrix} & \begin{matrix}( 1 - cos ( w ) ) {r}_{x} {r}_{z} + \\ sin ( w ) {r}_{y}\end{matrix} & {t}_{x} \\ \begin{matrix}( 1 - cos ( w ) ) {r}_{x} {r}_{y} + \\ sin ( w ) {r}_{z}\end{matrix} & \begin{matrix}( 1 - cos ( w ) ) {r}_{y}^{2} + \\ cos ( w )\end{matrix} & \begin{matrix}( 1 - cos ( w ) ) {r}_{x} {r}_{z} + \\ sin ( w ) {r}_{y}\end{matrix} & {t}_{y} \\ \begin{matrix}( 1 - cos ( w ) ) {r}_{x} {r}_{z} - \\ sin ( w ) {r}_{y}\end{matrix} & \begin{matrix}( 1 - cos ( w ) ) {r}_{y} {r}_{z} + \\ sin ( w ) {r}_{x}\end{matrix} & \begin{matrix}( 1 - cos ( w ) ) {r}_{z}^{2} + \\ cos ( w )\end{matrix} & {t}_{z}\end{matrix} ]$$

When the movement ratio of the motor 12 is known and expressed as: rₓ:r_{y}:r_{z}=1: α: β, the coordinate transformation matrix can be simplified as:

$$[ \begin{matrix}\begin{matrix}( 1 - cos ( w ) ) {r}_{x}^{2} + \\ cos ( w )\end{matrix} & \begin{matrix}1 - cos ( w ) α {r}_{x}^{2} - \\ sin ( w ) β {r}_{x}\end{matrix} & \begin{matrix}( 1 - cos ( w ) ) β {r}_{x}^{2} + \\ sin ( w ) α {r}_{x}\end{matrix} & {t}_{x} \\ \begin{matrix}( 1 - cos ( w ) ) α {r}_{x}^{2} + \\ sin ( w ) β {r}_{x}\end{matrix} & \begin{matrix}( 1 - cos ( w ) ) {α}^{2} {r}_{x}^{2} + \\ cos ( w )\end{matrix} & \begin{matrix}( 1 - cos ( w ) ) αβ {r}_{x}^{2} - \\ sin ( w ) {r}_{x}\end{matrix} & {t}_{y} \\ \begin{matrix}( 1 - cos ( w ) ) β {r}_{x}^{2} - \\ sin ( w ) α {r}_{x}\end{matrix} & \begin{matrix}( 1 - cos ( w ) ) αβ {r}_{x}^{2} + \\ sin ( w ) {r}_{x}\end{matrix} & \begin{matrix}( 1 - cos ( w ) ) {β}^{2} {r}_{x}^{2} + \\ cos ( w )\end{matrix} & {t}_{z}\end{matrix} ]$$

The simplified coordinate transformation matrix and the corresponding coordinate of each feature point are substituted into the equation (1) of feature comparison to obtain the values of rₓ, tₓ, t_{y}, t_{z}.

In step S405, the axis coordinate of the motor 12 and the radius R of rotation of the motor 12 are obtained according to a set of simultaneous equations:

(Px0−A)²+(Py0−B)²+(Pz0−C)²=R²,(Px1−A)²+(Py1−B)²+(Pz1−C)²=R²,

(Px2−A)²+(Py2−B)²+(Pz2−C)²=R²,(Px3−A)²+(Py3−B)²+(Pz3−C)²=R².

In step S406, the first, the second and the third revolution of the feature point in the coordinate system of the motor 12 are calculated according to the axis coordinate of the motor 12 and the radius R of rotation of the motor 12 being calculated. In step S407, whether the first, the second and the third revolution of the feature point conform to the movement amount of the motor 12 at each time of rotation is determined. If yes, the step S408 is proceeded, a comparison result obtained from the iterative algorithm is outputted. If no, the method returns to steps S402-S406, the iterative algorithm is repeated, another three coordinate transformation matrixes are obtained and the axis coordinate of the motor 12 and the radius of rotation of the motor 12 are re-calculated until the revolution of the feature point at each time of rotation is conformed to the movement amount of the motor 12 at each time of rotation.

In step S405, since the feature point of the object 14 is moved by the shaft of the motor 12, the feature point will move along a surface of a specific sphere in the space, and the axis coordinate and radius of rotation of the motor 12 can be obtained from four sets of coordinate data and used as the center of sphere. Then, in the steps S406 and S407, whether the revolution of the feature point at each time of rotation (angle) is conformed to the movement amount of the motor 12 at each time of rotation is determined, such that whether the comparison position is correct during the process of iterative calculation will be confirmed.

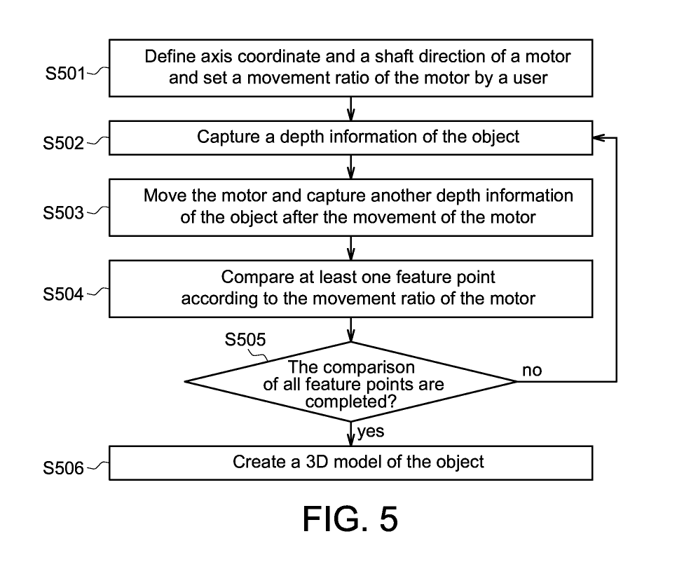

Referring to FIG. 5, a flowchart of an object scanning method according to an embodiment of the disclosure is shown. In step S501, when the motor 12 is moved linearly or is rotated, the user, based on visual estimation, inputs and sets axis coordinate and shaft direction of the motor 12 to the coordinate system of the depth sensor 11 to limit the searching scope during the comparison process. Suppose the motor 12 is translated. During movement, the motor 12 must be moved along a direction of some vector (x,y,z) in the coordinate system of the depth sensor 11, and thus a movement ratio is set as: x:y:z=a:b:c (such as 1:0:0). If the motor 12 is rotated, the motor 12 will be rotated around a fixed shaft direction (Rx, Ry, Rz), and thus a movement ratio is set as: rₓ:r_{y}:r_{z}=1: α: β. In step S502, an object 14 is scanned and a depth information of the object 14 is captured by a depth sensor 11. In step S503, the motor 12 is moved and another depth information of the object 14 after the movement of the motor 12 is captured at least once. In step S504, each time when the motor 12 is moved, the feature comparison step of FIG. 3 is performed according to the inputted movement ratio of the motor 12, that is, x:y:z=a:b:c, to obtain correct values of a, b, c and reduce the volume and computing time of the iterative algorithm. Or, the method proceeds to step S504, when the motor 12 is rotated, a comparison of at least one feature point is made between two depth information of the object 14 according to the inputted axis coordinate and movement ratio of the motor 12, that is, rₓ:r_{y}:r_{z}=1:a:0, and the iterative algorithm is optimized, such that correct axis coordinate and shaft direction of the motor 12 can be obtained and the volume and computing time of the iterative algorithm can be reduced. In step S505, after the comparison of each feature point is completed, the step S506 is proceeded, a 3D model of the object 14 is created according to the corresponding coordinate of each feature point.

In step S504, when the motor 12 is moved linearly, the feature comparison steps are the same as steps S301-S303. Since the movement ratio of the motor, that is, x:y:z=a:b:c (such as 1:0:0), in a known movement direction can be already predetermined, the searching scope during comparison can be limited, and the volume and computing time of the iterative algorithm can be reduced.

In step S504, when the motor 12 is rotated, the feature comparison steps are the same as steps S401-S402, initial coordinate [Px0, Py0, Pz0] of the feature point before the rotation of the motor 12 are captured, axis coordinate of the motor 12 are set as (A, B, C), and radius of rotation of the motor 12 is set as R, wherein (Px0−A)²+(Py0−B)²+(Pz0−C)²=R². Then, a coordinate transformation matrix from the coordinate system of the depth sensor 11 to the coordinate system of the motor 12 and the coordinate [Px1, Py1, Pz1] of the feature point after the rotation of the motor 12 are set according to the movement amount after the rotation of the motor 12 and the revolution of the feature point in the coordinate system of the motor 12, wherein (Px1−A)²+(Py1−B)²+(Pz1−C)²=R². Since the axis coordinate of the motor 12 and the radius of rotation of the motor 12 are already estimated, steps S403-S407 can be omitted and the method only needs to optimize on the iterative algorithm, such that correct axis coordinate and shaft direction of the motor 12 can be estimated and the volume and computing time of the iterative algorithm can be reduced.

According to the object scanning method disclosed in above embodiments of the disclosure, the depth sensor does not calibrate with the motor but directly scans an object, and the movement information of the motor (such as distance of movement or angle of rotation) is used as constraints during the comparison of feature point, such that corresponding coordinate of each feature point can be found out and a 3D model of the object can be created.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An object scanning method, comprising:
scanning an object and capturing a depth information of the object by a depth sensor;
moving a motor and capturing another depth information of the object after the movement of the motor at least once;
capturing a movement amount of the motor under the circumstance that axis coordinate of the motor are not calibrated;
comparing at least one feature point between two depth information of the object according to the movement amount of the motor, and obtaining corresponding coordinate of each feature point by using an iterative algorithm until the comparison of each feature point is completed; and
creating a 3D model of the object according to the corresponding coordinate of each feature point.

2. The scanning method according to claim 1, wherein when the motor is moved linearly, another depth information of the object after the movement of the motor is captured at least once.

3. The scanning method according to claim 2, wherein the step of comparing the feature point comprises:
setting an equation of a coordinate transformation matrix from a coordinate system of the depth sensor to the coordinate system of the motor and a translational vector of a movement of the feature point in the coordinate system of the motor according to the movement amount of the motor and the coordinates of the feature point before/after the movement of the motor, wherein the movement amount of the motor is set as X, the translational vector is set as [tₓ, t_{y}, t_{z}], and tₓ²+t_{y}²+t_{z}²=X²;
performing the iterative algorithm on the equation to determine whether the movement of the feature point satisfies the translational vector; and
obtaining the corresponding coordinate of the feature point after the movement of the motor according to the iterative algorithm.

4. The scanning method according to claim 1, wherein when the motor is rotated, another depth information of the object after the movement of the motor is captured at least three times.

5. The scanning method according to claim 4, wherein the axial direction of the motor is fixed during each time of movement.

6. The scanning method according to claim 4, wherein the step of comparing the feature point comprises:
capturing initial coordinate [Px0, Py0, Pz0] of the feature point before the rotation of the motor and setting axis coordinate of the motor as (A, B, C) and a radius of rotation of the motor as R, wherein (Px0−A)²+(Py0−B)²+(Pz0−C)²=R²;
setting a first coordinate transformation matrix from a coordinate system of the depth sensor to the coordinate system of the motor and the coordinate [Px1, Py1, Pz1] of the feature point after the first time of rotation according to the movement amount of the motor at the first time of rotation and a first revolution of the feature point in the coordinate system of the motor, wherein (Px1−A)²+(Py1−B)²+(Pz1−C)²=R²;
setting a second coordinate transformation matrix from the coordinate system of the depth sensor to the coordinate system of the motor and the coordinate [Px2, Py2, Pz2] of the feature point after the second time of rotation according to the movement amount of the motor at the second time of rotation and a second revolution of the feature point in the coordinate system of the motor, wherein (Px2−A)²+(Py2−B)²+(Pz2−C)²=R²;
setting a third coordinate transformation matrix from the coordinate system of the depth sensor to the coordinate system of the motor and the coordinate [Px3, Py3, Pz3] of the feature point after the third time of rotation according to the movement amount of the motor at the third time of rotation and a third revolution of the feature point in the coordinate system of the motor, wherein (Px3−A)²+(Py3−B)²+(Pz3−C)²=R²;
obtaining the axis coordinate of the motor and the radius of rotation of the motor according to a set of simultaneous equations:
(Px0−A)²+(Py0−B)²+(Pz0−C)²=R²,(Px1−A)²+(Py1−B)²+(Pz1−C)²=R²,
(Px2−A)²+(Py2−B)²+(Pz2−C)²=R²,(Px3−A)²+(Py3−B)²+(Pz3−C)²=R²;
performing the iterative algorithm to calculate the first, the second and the third revolution of the feature point in the coordinate system of the motor according to the axis coordinate of the motor and the radius of rotation of the motor; and
outputting a comparison result obtained from the iterative algorithm.

7. The scanning method according to claim 6, further comprising determining whether the first, the second and the third revolutions of the feature point conform to the movement amount of the motor at each time of rotation.

8. The scanning method according to claim 1, wherein the iterative algorithm adopts a parallel tracking and mapping (PTAM) method.

9. The scanning method according to claim 1, wherein the iterative algorithm adopts an iterative closest point (ICP) method.

10. The scanning method according to claim 1, wherein the object has translational symmetry feature or circular symmetry feature.

11. An object scanning method, comprising:
defining axis coordinate and a shaft direction of a motor and setting a movement ratio of the motor in a known movement direction by a user;
scanning an object and capturing a depth information of the object by a depth sensor;
moving the motor and capturing another depth information of the object after the movement of the motor at least once;
capturing a movement amount of the motor;
comparing at least one feature point between two depth information of the object according to the known movement ratio of the motor and obtaining corresponding coordinate of each feature point by using an iterative algorithm until the comparison of each feature point is completed; and
creating a 3D model of the object according to the corresponding coordinate of each feature point.

12. The scanning method according to claim 11, further comprising optimizing the iterative algorithm to estimate correct axis coordinate and correct shaft direction of the motor.

13. The scanning method according to claim 11, wherein when the motor is moved linearly, the step of comparing the feature point comprises:
setting an equation of a coordinate transformation matrix from a coordinate system of the depth sensor to the coordinate system of the motor and a translational vector of a movement of the feature point in the coordinate system of the motor according to the movement amount of the motor and the coordinates of the feature point before/after the movement of the motor, wherein the movement amount of the motor is set as X, the translational vector is set as [tₓ, t_{y}, t_{z}], and tₓ²+t_{y}²+t_{z}²=X²;
performing the iterative algorithm on the equation according to the movement ratio of the motor in the known movement direction to determine whether the movement of the feature point satisfies the translational vector; and
obtaining the corresponding coordinate of the feature point after the movement of the motor by using the iterative algorithm.

14. The scanning method according to claim 11, wherein when the motor is rotated, the step of comparing the feature point comprises:
capturing initial coordinate [Px0, Py0, Pz0] of the feature point before the rotation of the motor and setting axis coordinate of the motor as (A, B, C) and a radius of rotation of the motor set as R, wherein (Px0−A)²+(Py0−B)²+(Pz0−C)²=R²;
setting a coordinate transformation matrix from a coordinate system of the depth sensor to the coordinate system of the motor and the coordinate [Px1, Py1, Pz1] of the feature point after the rotation of the motor according to the movement amount after the rotation of the motor and a revolution of the feature point in the coordinate system of the motor, wherein (Px1−A)²+(Py1−B)²+(Pz1−C)²=R²;
performing the iterative algorithm to calculate the revolution of the feature point in the coordinate system of the motor according to the user-defined axis coordinate and the radius of rotation of the motor; and
estimating correct axis coordinate and shaft direction of the motor by using the iterative algorithm.

15. The scanning method according to claim 11, wherein the iterative algorithm adopts a parallel tracking and mapping (PTAM) method.

16. The scanning method according to claim 11, wherein the iterative algorithm adopts an iterative closest point (ICP) method.

17. The scanning method according to claim 11, wherein the object has translational symmetry feature or circular symmetry feature.
